(19) United States
(12) Patent Application Publication
(10) Pub. No.: US 2007/0063907 A1
(43) Pub. Date: Mar. 22, 2007

(54) Wireless communication system and method

(75) Inventors: Shigeru Hatakeyama, Tokyo (JP); Shigeru Yamazaki, Tokyo (JP); Hiroki Murayama, Tokyo (JP); Koichi Hirano, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/520,798

(22) Filed: Sep. 14, 2006

(30) Foreign Application Priority Data
Sep. 16, 2005 (JP) 2005-271189

(51) Int. Cl. H01Q 3/00

(52) U.S. Cl. 343/757; 343/761

(57) ABSTRACT

The wireless communication system comprises a main antenna for radiating electromagnetic waves towards the wireless IC chips; reflecting plates for forming detour paths of electromagnetic waves that are interfered with the managing targets to which the wireless IC chips are attached; and a posture control unit for controlling facing direction of the wireless IC chips with respect to the electromagnetic waves that travel the detour paths formed by the reflecting plates. The reflecting plates form the detour paths of the electromagnetic waves that are interfered with the managing targets to which the wireless IC chips are attached, so that the electromagnetic waves from the main antenna can reach the wireless IC chips through the detour paths. Furthermore, the posture control unit controls the facing direction of the wireless IC chips with respect to the electromagnetic waves that travel the detour paths formed by the reflecting plates, so that the electromagnetic waves from the main antenna can make incident on the wireless IC chips through the detour paths formed by the reflecting plates.

### BACKGROUND OF THE INVENTION

1. Field of the Invention

The present invention relates to a wireless communication system and a method for performing reading/writing communication between a main antenna and wireless IC chips attached to articles piled up stereoscopically, for example.

2. Description of the Related Art

There has been required a device that is capable of collectively obtaining and managing information of articles piled up on a floor or a stand of a store or a factory, or information of articles piled up on a dolly and the like passing through the passage of a store or a production line. It becomes possible to manage a plurality of articles collectively through attaching RFID tags to the plurality of articles and reading out the information on the RFID tags or writing information of the articles to the RFID tags by a reader/writer.

Japanese Patent Laid-Open Publication No. 2005-5876 discloses a configuration including an antenna for radiating a recognition area with an inquiry electromagnetic wave and a reflecting plate arranged opposite thereto to thereby extend the recognition area. Japanese Patent Laid-Open Publication No. 2005-4532 discloses a configuration in which a plurality of antennas are arranged circumferentially around a turntable mounting a wireless data carrier. Japanese Patent Laid-Open Publication No. 2004-265112 discloses a configuration in which a plurality of antennas are arranged in a height direction around an article mounting part.

It is true that the wireless communication systems disclosed in the above-mentioned patent documents are capable of effectively guiding the direct electromagnetic waves from the antennas or the electromagnetic waves reflected by the reflecting plates to the RFID tags of the articles through utilizing the positional relation between the plurality of antennas and the reflecting plates.

However, the above-described patent documents are not provided assuming such cases where the articles, the managing targets to which the RFID tags are attached, are metal products or liquid and the like filled in containers. Thus, the electromagnetic waves from the antenna are reflected by the surfaces of the articles or absorbed by the articles. Therefore, the electromagnetic waves from the antenna cannot reach the RFID tags so that it is not possible to perform reading/writing collectively on the plurality of RFID tags by a single antenna provided above the passage or the production line.

### SUMMARY OF THE INVENTION

The object of the present invention is to provide a wireless communication system and a method which are capable of securely performing communication by the electromagnetic waves between a main antenna and wireless IC chips regardless of the types of the managing targets such as the articles to which the wireless IC chips are attached.

In order to achieve the above-mentioned object, the wireless communication system according to the present invention comprises: a main antenna for radiating electromagnetic waves to wireless IC chips; a reflecting plate for forming a detour path of an electromagnetic wave that is interfered with a managing target to which the wireless IC chip is attached; and a posture control unit for controlling facing direction of the wireless IC chip with respect to the electromagnetic wave that travels the detour path formed by the reflecting plate.

There will be considered the case where the managing target to which the wireless IC chip is attached is a metal case or the like, and electromagnetic waves are radiated from the main antenna to the wireless IC chip. When the main antenna is attached to the ceiling or the like of a building structure and the wireless IC chip is attached to the side face of the metal case, the electromagnetic waves radiated from the main antenna positioned above the metal case are reflected by the top face of the metal case. Thus, the electromagnetic waves cannot reach the wireless IC chip attached to the side face of the metal case.

In the present invention, however, the reflecting plate forms the detour path of the electromagnetic wave that is interfered with the managing target to which the wireless IC chip is attached. Therefore, the electromagnetic wave from the main antenna can reach the wireless IC chip through the detour path. Further, the posture control unit controls the facing direction of the wireless IC chip with respect to the electromagnetic wave that travels the detour path formed by the reflecting plate.

Therefore, the electromagnetic wave that travels the detour path formed by the reflecting plate comes to reach the wireless IC chip, so that information transmitted by the electromagnetic wave radiated from the main antenna can be demodulated on the wireless IC chip side. With this, it becomes possible to perform wireless communication between the wireless IC chip attached to the metal case and the main antenna by building a data communication circuit between those via the electromagnetic waves.

In order to control the facing direction of the wireless IC chip with respect to the electromagnetic wave that travels the detour path formed by the reflecting plate, it can be achieved by the posture control unit having a structure for angularly rotating the managing target to which the wireless IC chips is attached. Specifically, it is the structure for angularly rotating a dolly that supports the managing target or the structure for angularly rotating the managing target on the dolly.

Further, there are the reflecting plates arranged on a plurality of stages along the mount direction of the managing targets. In this case, it is desirable for the reflecting plates to be arranged on one side or both sides of the mounted managing targets.

Furthermore, in order to execute a wireless communication method by using the wireless communication system according to the present invention, there are executed the steps of: in addition to paths of electromagnetic waves radiated from a main antenna to a wireless IC chip, a path forming step for forming a detour path of an electromagnetic wave that is interfered with a managing target to which the wireless IC chip is attached; and a posture control step for controlling facing direction of the wireless IC chip with respect to the electromagnetic wave that travels the detour path formed by the reflecting plate.

In the present invention as described above, the electromagnetic waves from the main antenna are directed towards the wireless IC chips of the managing targets through the detour paths formed by the reflecting plates even in the case where the managing targets are metal-made items or liquids which reflect or absorbs the electromagnetic waves. Therefore, even if the electromagnetic waves from the main antenna are interfered with the managing targets, the electromagnetic waves can be surely led to the wireless IC chips. As a result, data communication paths by the electromagnetic waves can be established between the wireless IC chips and the main antenna regardless of the types of the materials of the managing targets.

### BRIEF DESCRIPTION OF THE DRAWINGS

FIG. 1 is a configuration diagram for showing a wireless communication system according to a first embodiment of the present invention;

FIG. 2 is a configuration diagram for showing a wireless communication system according to a second embodiment of the present invention;

FIG. 3 is a configuration diagram for showing a wireless communication system according to a third embodiment of the present invention; and

FIG. 4 is a configuration diagram for showing a wireless communication system according to a fourth embodiment of the present invention.

### DETAILED DESCRIPTION OF TE PREFERRED EMBODIMENTS

Embodiments of the present invention will be described hereinafter by referring to the accompanying drawings.

As the fundamental structure, a wireless communication system according to the embodiments of the present invention comprises: a main antenna 2 for radiating electromagnetic waves towards wireless IC chips (3); reflecting plates 4 to form detour paths of the electromagnetic waves that are interfered with managing targets (13) to which the wireless IC chips (3) are attached; and a posture control unit 8 for controlling the facing directions of the wireless IC chips (3) with respect to electromagnetic waves 7a that travel the detour paths formed by the reflecting plates 4.

The main antenna 2 radiates the electronic waves outputted from a transmitting/receiving device (1) to the wireless IC chips (3). The embodiment of the present invention will be described by referring to the case where RFID tags 3 are used as the wireless IC chips and a reader/writer for managing the RFID tags 3 is used as the transmitting/receiving device. It is noted that each of the RFID tags comprises an antenna, a memory, and the like. The reader/writer 1 has a function of reading information from the RFID tags 3 and writing information to the RFID tags with the electromagnetic waves. The reader/writer 1 transmits and receives data signals using electromagnetic waves with the RFID tags 3 by the main antenna 2. These RFID tags and the reader/writer used herein are of the general-purpose types. Further, a first embodiment is described by referring to the case where metal cases 13 are used as the managing targets.

(First Embodiment)

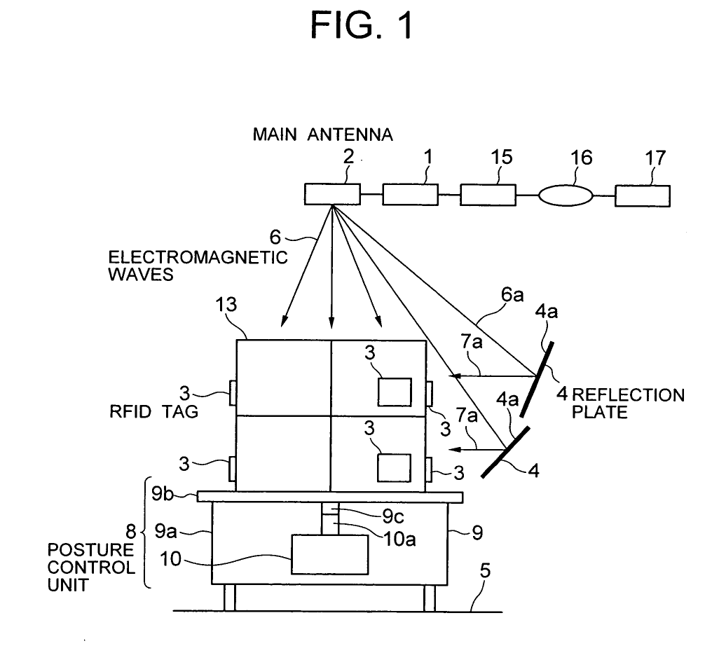

FIG. 1 shows the first embodiment of the present invention. As shown in FIG. 1, a plurality of metal cases 13 to which the RFID tags 3 are attached are piled up on a dolly 9 to be conveyed to a management area 5. The management area 5 may be a store or a warehouse in a distribution process, or a passage of a store or a part passing through a production line. The point is that the management area 5 refers to a space where the managing targets such as the metal cases to which the RFID tags 3 are attached enter.

The main antenna 2 of the reader/writer 1 is placed downwards at a position above the management area 5, e.g. at the ceiling of the factory, so that a traveling direction of the electromagnetic waves is directed towards the management area 5 for allowing the electromagnetic waves from the main antenna 2 to cover most of the area within the management area 5.

A computer terminal 15 is connected to the reader/writer 1, and information is exchanged between the reader/writer 1 and the computer terminal 15. Further, the computer terminal 15 is connected to a server 17 over a network 16. Information from the computer terminal 15 is accumulated in the server 17, and the information is outputted from the server 17 to the computer terminal 15 over the network 16. The server 17 organizes the information inputted from the reader/writer 1 into a database, and maintains the information so as to be usable in the goods management of a store, production management of a factory and the like.

The metal cases 13 to which the RFID tags 3 are attached are piled up on a dolly 9. The metal cases 13 are often adjusted into a standardized dimension so as to be fitted for transportation by trucks, railways, airs, etc. Thus, there may be cases where the RFID tag 3 is attached to a specific position of the metal case 13 such as the top face or the side face of the metal case 13 because it is convenient in terms of management, for example. Therefore, when these kinds of metal cases 13 are loaded on the dolly 9, they may be loaded in an orderly manner with the RFID tags 3 facing towards the outer side.

If the electromagnetic waves 6 are radiated downwards from the main antenna 2 at the ceiling when forming communication paths by the electromagnetic waves for data communication between the RFID tags 3 attached to the metal cases 13 and the main antenna 2, the electromagnetic waves 6 towards the antennas of the RFID tags 3 are reflected by the top faces of the metal cases 13. Thus, the electromagnetic waves cannot reach the antennas of the RFID tags 3 which are attached to the side faces of the metal cases 13.

Interference to the electromagnetic waves directed towards the RFID tags 3 of the managing targets 13 is not limited only to the case where the managing targets 13 are the metal cases. There are also cases where the electromagnetic waves radiated towards the RFID tags are interfered when a solvent filled in a container as the managing target 13 is a substance that absorbs or reflects the electromagnetic waves.

Thus, the embodiment utilizes electromagnetic waves 6a radiated from the main antenna 2 without being interfered with the managing targets 13, and forms the detour paths of the electromagnetic waves 6 that are interfered with the managing targets 13 by using the reflecting plates 4. With this, the electromagnetic waves 6a radiated from the main antenna 2 are reflected by a reflecting faces 4a of the reflecting plates 4 in the horizontal direction or at an angle close to the horizontal direction. This allows the electromagnetic waves 6a instead of the electromagnetic waves 6 from the main antenna 2 to travel in the detour paths formed by the refection plates 4 so as to reach the RFID tags 3 of the managing targets 13 as reflected waves 7a.

A plurality of reflecting plates 4 reflect the electromagnetic waves from the main antenna 2 of the reader/writer 1 and advance them towards the RFID tags 3 within the management area 5. Each of the reflecting plates 4 is so configured that the a reflecting surface 4a is formed on a surface to which an electromagnetic wave is made incident by metal finishing or applying an electromagnetic-reflecting agent so as to reflect the electromagnetic wave at the reflecting surface 4a. In the embodiment shown in FIG. 1, the reflecting plates 4 are arranged in two upper and lower stages in a vertical direction. Note that the number of arranged stages of the reflecting plates 4 is not limited to two. The number of arranged stages of the reflecting plates 4 changes depending on the piled height of the metal cases 13 piled up on the dolly 9. For example, if the width of the reflecting plate 4 is narrow, the number of arranged stages of the reflecting plates 4 is large, and if the piled height of the metal cases 13 piled up on the dolly 9 is high, the number of arranged stages of the reflecting plates 4 is large.

The plurality of reflecting plates 4 are arranged in multiple stages, and the reflecting surfaces 4a thereof are held in tilted postures. The tilt angle of the reflecting face 4a is set at an angle with which the electromagnetic waves 6a radiated from the main antenna 2 towards the directions of each reflecting plate 4 are reflected by the reflecting plates 4 in the horizontal direction or at an angle close to the horizontal direction, and the reflected waves 7a thereof are directed towards the RFID tags 3 attached to the side faces of the metal cases 13 that are piled up stereoscopically.

The tilt angles of the reflecting plates 4 are changed in accordance with the positions where the electromagnetic waves 6a from the main antenna 2 make incident. In the case shown in the drawing, the tilt angle of the reflecting plate 4 for reflecting the electromagnetic wave 7a towards the RFID tag 3 positioned at the upper stage is set to be small, and the tilt angle of the reflecting plate 4 for reflecting the electromagnetic wave 7a towards the RFID tag 3 positioned at the lower stage is set to be large. Those tilt angles of the reflecting plates 4 are merely examples, so they may be selected appropriately by taking statistics of antenna directions of the RFID tags 3 entered in the management area 5, or according to the empirical rules. In other words, it is only necessary that electromagnetic waves 6a from the main antenna 2 of the reader/writer 1 can arrive at the antennas of all RFID tags 3 in the management area 5 by using the reflecting plates 4 having the reflecting surfaces 4a, irrespective of the electromagnetic waves 6 interfered with the metal case 13. Further, if the width of the reflecting plate 4a is in the same length of the wavelength of an electromagnetic wave or a length of ¾ or 2/1 of the wavelength, resonance phenomenon of the electromagnetic wave is caused on the reflecting surface 4a and attenuated, whereby the power of the reflected waves 7a is lowered. Therefore, the width of the reflecting plate 4 is set to be not less than the wavelength of the electromagnetic wave.

Further, the reflecting surface 4a of the reflecting plate 4 is formed in a shape of plane, two-dimensional parabolic face, cylindrical face, elliptical face or the like. If the shape of the reflecting surface 4a is a two-dimensional parabolic face, a cylindrical face, an elliptical face or the like, it is possible to suppress diffusion of the reflected wave from the reflecting surface 4a at minimum, compared with a reflecting surface 4a of a plane shape. Further, if the reflecting surface 4a is a two-dimensional parabolic face dished inward, a reflected wave shows a parallel radiation characteristic. If the reflecting surface 4a is a cylindrical face or an elliptical face dented inward, the reflected wave shows a condensing radiation characteristic. The reflecting surface 4a may be in a shape of two-dimensional parabolic face, cylindrical face, elliptical face or the like protruded outwardly, depending on the cases.

Further, as the antenna provided to the RFID tag 3, an antenna of a general-purpose structure such as a flat antenna, a dipole antenna, a monopole antenna or a turnstile antenna is used. A turnstile antenna is an antenna in which two dipole antennas are combined in a positional relationship of 90 degrees to each other. Communications from the main antenna 2 to the antenna of the RFID tag 3 are performed by using a circularly polarized wave. When the antenna of the RFID tag 3 receives an electromagnetic wave, it can receive either of the clockwise-turning and counterclockwise-turning circularly polarized waves. If the antenna of the RFID tag 3 is a dipole antenna, a monopole antenna or a turnstile antenna, it can receive electromagnetic waves from front and back surface directions and from side surface directions. If the antenna of the RFID tag 3 is a flat antenna, it can receive electromagnetic waves from front and back surfaces directions of the RFID tag 3. In the case of a flat antenna, the receiving electromagnetic wave level changes depending on the size of the reception effective area with respect to the electromagnetic wave radiated from the main antenna 2.

The posture control unit 8 has a function of controlling the facing directions of the RFID tags 3, specifically the antenna surfaces thereof, with respect to the electromagnetic waves 7a that travel the detour paths formed by the reflecting plates 4.

In the embodiment, the posture control unit 8 is constituted with the dolly 9 used for conveying articles and the like. This will be described specifically. As shown in FIG. 1, the dolly 9 constituting the posture control unit 8 includes a vehicle body 9a for moving articles mounted thereon, a top plate 9b for supporting the articles, and a power source 10 for rotational driving.

The top plate 9b is supported to be angularly rotatable around the rotary shaft 9c on top of the vehicle body 9a, and is adapted such that the metal cases 13 provided with the RFID tags 3 are mounted stereoscopically thereon. The driving source 10 is so formed that the output shaft 10a thereof is connected with the rotary shaft 9c of the top plate 9b. The driving source 10 is controlled based on an instruction from the server 17 so as to angularly rotate the top plate 9b.

When the vehicle body 9a enters the management area 5, the driving source 10 angularly rotates the top plate 9b to control the RFID tags 3, specifically the facing direction of the antenna surfaces, with respect to the electromagnetic waves 7a that travel the detour paths formed by the reflecting plates 4.

Next, there will be described the operation of the wireless communication system according to the embodiment of the present invention. The RFID tags 3 are attached to the metal cases 13 to be identified. Then, to the RFID tag 3, information required for identifying the article is written by using an information writing device not shown. Those RFID tags to which the information is written are attached to the metal cases 13 and transported into the management area 5, so that a plurality of RFID tags 3 are to enter the inside the management area 5.

In the management area 5 where a plurality of RFID tags 3 are collected, an electromagnetic wave from the main antenna 2 of the reader/writer 1 disposed on the ceiling of the management area 5 is radiated at timing of carrying in articles for example, and based on the electromagnetic wave, the reader/writer reads information of the RFID tags 3 to thereby manage the managing targets.

However, as described above, the antennas of the RFID tags 3 are attached to the side faces of the metal cases 13 and facing towards the horizontal direction. In addition, the metal cases 13 reflect the electromagnetic waves 6 that are radiated from the main antenna 2 towards the antenna surfaces of the RFID tags 13. Thus, it is not possible for the electromagnetic waves 6 radiated from the main antenna 2 to reach the antenna surfaces of the RFID tags 3.

When the dolly 9 enters the management area 5 where the multiple reflecting plates 4 are arranged in a plurality of stages in up and down, there are formed the detour paths with which the electromagnetic waves from the main antenna 2 can reach the RFID tags 3 through the reflecting faces 4a of the reflecting plate 4, in addition to the paths of the electromagnetic waves that directly reach the antennas of the RFID tags from the main antenna 2. The RFID tags 3 attached on the top faces of the metal cases 13 receive the electromagnetic waves that are directly radiated towards the RFID tags 3 from the main antenna 2 for performing the data communication.

When the electromagnetic waves 6 radiated from the main antenna 2 of the reader/writer 1 are reflected by the metal cases 13, the reflected waves 7a that are reflected by the reflecting faces 4a travel in the detour paths formed by the reflecting plates 4. The reflected waves 7a make incident on the antennas of the RFID tags 3, and there is performed the bidirectional communication by the electromagnetic waves through the use of the antennas of the RFID tags 3 and the main antenna 2 of the reader/writer 1. Thereby, the information written on the RFID tags are collected by the reader/writer 1 and transmitted to the computer terminal 15. The computer terminal 15 supplies the information obtained from the reader/writer 1 to the server 17 through a network 16. The server 17 manages the articles to which the RFID tags 3 are attached, based on the information supplied from the computer terminal 15. The server 17 sends out the information to the computer terminal 15 through the network 16, when there is a change in the information of the article management or it becomes necessary to add new information thereto.

Upon receiving the information from the server 17, the computer terminal 15 transmits the information to the reader/writer 1. The reader/writer 1 radiates the received information from the main antenna 2 to the management area 5 by the electromagnetic waves. When the RFID tags 3 receive the information from the reader/writer 1 directly from the main antenna 2, the information is written to the memories of the corresponding RFID tags 3.

It is true that the reflected waves 7a reflected by the reflecting plates 4 are to reach the RFID tags 3 that are located at an area where the direct waves 6 from the main antenna 2 are not reachable. Nevertheless, there are cases where the reflected waves 7a reflected by the reflecting plates 4 cannot make incident, depending on the positions of the RFID tags 3. For example, it is a case where the RFID tag 3 of the metal case 13 is positioned on the opposite side of the place where the reflecting plate 4 is located.

Thus, the posture control unit 8 controls the facing direction of the RFID tag 3 of the metal case 13 with respect to the reflected waves 7a that are reflected by the reflecting face 4a of the reflecting plate 4.

Specifically, when the dolly 9 moves to the underneath the main antenna 2, the driving source 10 angularly rotates the top plate 9b of the dolly 9 to rotate the single or plurality of RFID tags 3 attached to the single or plurality of metal cases 13. At the same time, the computer terminal 15 outputs control signals to the main antenna 2 through the reader/writer 1 to perform communication repeatedly with the plurality of RFID tags 3 that are piled up stereoscopically on the dolly 9. The main antenna 2 transmits inquiry signals (electromagnetic waves) to the RFID tags 3 repeatedly, and performs communication with each of the RFID tags 3 that have responded to the inquiry signals.

The level of the electromagnetic waves received by the RFID tag 3 changes according to the electromagnetic wave reflectance or electromagnetic wave absorptance of the metal case 13 that is on the path from the main antenna 2 to the RFID tag 3, the length of the path from the main antenna 2 to the RFID tag 3, the radiating direction from the main antenna 2 or the reflecting plate 4, and the facing direction of the antenna surface of the RFID tag 3. When it is assumed in the case where the antenna of the RFID tag 3 is the monopole antenna or the dipole antenna that the length of the antenna of the RFID tag 3 viewed from the radiating direction of the electromagnetic waves is the reception effective length and assumed in the case where the antenna is the flat antenna that the area of the antenna surface of the RFID tag 3 viewed from the radiating direction of the electromagnetic waves is the reception effective area, the reception effective length or the reception effective area becomes the maximum when the radiating direction is vertical to the antenna surface of the RFID tag 3, and the level of the received electromagnetic waves becomes the maximum value.

The electromagnetic waves 6 from the main antenna 2 make incident directly on the RFID tag attached to the outermost top face of the metal case 13. The electromagnetic waves 6a among the electromagnetic waves 6, which are not interfered with the metal case 13, are radiated as the reflected waves 7a to the RFID tags 3 attached to the outer side faces of the metal cases 13 by the plurality of reflecting plates 4 from almost the horizontal direction.

When effective communication paths of the direct waves 6 or of the reflected waves 7a by utilizing the reflecting plates 4 are formed between the main antenna 2 and the RFID tags 3, the RFID tags 3 transmit reply signals towards the main antenna 2 in response to the inquiry signals from the main antenna 2. Further, communication is exchanged between the RFID tags 3 and the main antenna 2 for several times and the communication is ended. The computer terminal 15 stores the identification numbers of the RFID tags 3 which replied and with which communications have been completed, respectively.

The RFID tags 3 attached to the front faces, the left-side faces, and the rear faces of the metal cases 13 piled up on the dolly 9 cannot perform communication between the main antenna 2, since the direct waves 6 from the main antenna 2 and the reflected waves 7a from the reflecting plates 4 are reflected by the metal cases 13 and the level of the electromagnetic waves received by the antennas of the RFID tags 3 is deteriorated.

However, the effective communication paths via the reflected waves 7a from the reflecting plates 4 are formed between the RFID tags 3 attached to the right-side faces of the metal cases 13 and the main antenna 2. The RFID tags 3 transmit the reply signals towards the main antenna 2 in response to the inquiry signals from the main antenna 2 to start the communication. Further, communication is exchanged between the RFID tags 3 and the main antenna 2 for several times, and the communication is ended.

The metal cases 13 and the RFID tags 3 attached to the metal cases 13 on the dolly 9 continue to rotate angularly, and the inquiry signals from the main antenna 2 are also transmitted repeatedly. By the clockwise-turning at an angle of 90 degrees, the RFID tags 3 attached to the rear faces of the metal cases 13 come to face the reflecting faces 4a of the reflecting plates 4, thereby forming the effective communication paths by utilizing the reflecting plates 4. The RFID tags 3 at the rear faces transmit the reply signals towards the main antenna 2 in response to the inquiry signals from the main antenna 2 to start communication.

The velocity to angularly rotate the top plate 9b of the dolly 9 is set at a velocity capable of completing a series of communication in which the RFID tags 3 decode the inquiry signals from the reflected waves 7a and transmit the reply signals in response to the main antenna 2 via the reflecting plates 4, and the communication between the RFID tags 3 and the main antenna 2 is exchanged thereafter for several times to complete the communication. The computer terminal 15 stores the identification numbers of the RFID tags 3 which replied and with which communications have been completed, respectively.

Furthermore, the RFID tags 3 on the dolly 9 continue to rotate angularly, so that the RFID tags 3 attached to the left-side faces of the metal cases 13 come to face the reflecting faces 4a of the reflecting plates 4 by another clockwise-turning at an angle of 90 degrees to form the effective communication paths by utilizing the reflecting plates 4, and the RFID tags 3 attached to the front faces of the metal cases 13 come to face the reflecting faces 4a of the reflecting plates 4 by still another clockwise-turning at an angle of 90 degrees to form the effective communication paths by utilizing the reflecting plates 4.

By utilizing the reflecting plates 4, communication is exchanged with all the RFID tags 3 that are attached to the outer side faces of the metal cases 13 through rotary motion of at least 270 degrees, and the computer terminal 15 stores the identification numbers of the RFID tags 3 that have completed the communication.

The computer terminal 15 judges that communication with all the RFID tags 3 attached to the outer side faces of the metal cases 13 are completed and the identification numbers thereof are stored, and stops the transmission of the inquiry signals from the main antenna 2. At the same time, the angular rotation of the top plate 9b of the dolly 9 is stopped, and the dolly 9 starts to move ahead the passageways or the production line.

(Second Embodiment)

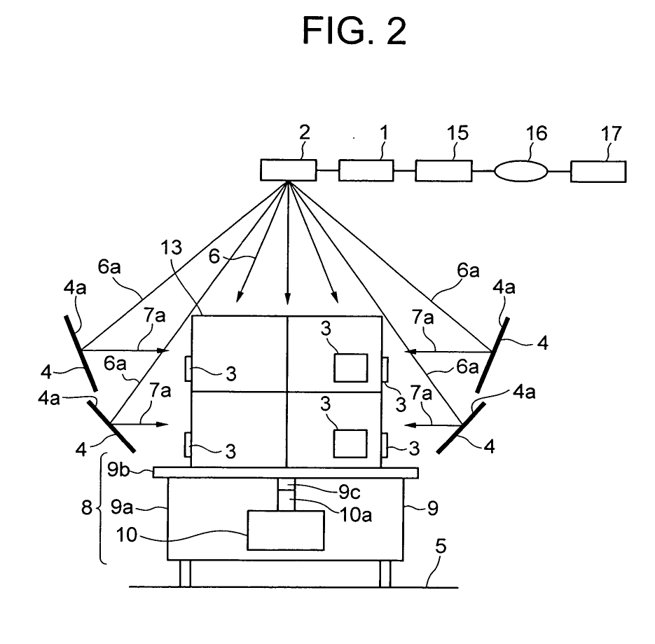

FIG. 2 is a configuration diagram for showing the wireless communication system according to a second embodiment of the present invention. In this embodiment of the present invention, the reflecting plates 4 shown in FIG. 1 are arranged to surround the management area 5. That is, a plurality of reflecting plates 4 are divided in two sets, and the respective sets of reflecting plates 4 are placed on opposite walls of a store or a factory or on opposite sides over a passage of a store or a production line of a factory by using fittings or the like so as to be arranged to surround the management area 5. Alternatively, a plurality of reflecting plates 4 may be hanged on both sides almost vertically from fittings or the like with ropes or the like. The plurality of reflecting plates 4 on both walls or on both sides are attached while being inclined to reflect the electromagnetic waves 6a from the main antenna 2 to radiate the reflected waves 7a in the horizontal direction or at an angle close to the horizontal direction. To the RFID tags 3 attached on the top faces of the metal cases 13 piled up stereoscopically, the direct electromagnetic wave 6 is radiated from the main antenna 2 from above, and to the RFID tags 3 attached to the side faces of the metal cases 13, the reflected waves 7a and 7b are radiated from the reflecting plates 4 arranged horizontally on the both sides.

In FIG. 2, for the RFID tags 3 attached to the right-side faces and the left-side faces of the metal cases 13 piled up on the dolly 9, there are formed the effective communication paths via the reflected waves 7a from each of the reflecting plates 4 on the right side and the left side. Thereby, communication can be performed between the main antenna 2.

However, the RFID tags 3 attached to the front faces and rear faces of the metal cases 13 cannot perform communication with the main antenna 2, since the direct waves 6 from the main antenna 2 and the reflected waves 7a from the reflecting plates 4 are reflected by the metal cases 13 and the level of received electromagnetic waves becomes deteriorated.

The velocity to angularly rotate the top plate 9b of the dolly 9 is set at a velocity capable of completing a series of communication in which the RFID tags 3 decode the inquiry signals from the reflected waves 7a and transmit the reply signals in response to the main antenna 2 via the reflecting plates 4, and the communication between the RFID tags 3 and the main antenna 2 is exchanged thereafter for several times to complete the communication.

The metal cases 13 and the RFID tags 3 attached to the metal cases 13 on the dolly 9 continue to rotate angularly, and the inquiry signals from the main antenna 2 are also transmitted repeatedly. By the clockwise-turning at an angle of 90 degrees, the RFID tags 3 attached to the rear faces of the metal cases 13 come to face the reflecting faces 4a of the reflecting plates 4 on the right side, and the RFID tags 3 attached to the front faces of the metal cases 13 come to face the reflecting faces 4a of the reflecting plates 4 on the left side so as to form the effective communication paths via the reflecting plates 4. The RFID tags 3 at the front and rear faces transmit the reply signals towards the main antenna 2 in response to the inquiry signals from the main antenna 2 to start communication.

By utilizing the reflecting plates 4 on both sides, communication is exchanged with all the RFID tags 3 that are attached to the outer side faces of the metal cases 13 through angular rotation of at least 90 degrees, and the computer terminal 15 stores the identification numbers of the RFID tags 3 that have ended the communication. The computer terminal 15 judges that communication with all the RFID tags 3 attached to the outer side faces of the metal cases 13 are completed and the identification numbers thereof are stored, and stops the transmission of the inquiry signals from the main antenna 2. At the same time, the angular rotation of the top plate 9b of the dolly 9 is stopped, and the dolly 9 starts to move ahead the passageways or the production line.

In the embodiment of the present invention, the reflecting plates 4 are arranged on both sides of the control area 5, and the communication paths of the electromagnetic waves utilizing the reflecting plates 4 are formed, respectively, between the main antenna 2 and the RFID tags 3 attached to the side faces of the metal cases 13. Thus, the embodiment is advantageous in respect that it is capable of controlling the posture within the range of at least 90 degrees for performing the data communication between the main antenna 2 and the RFID tags 3 attached to the side faces of the metal cases 13.

(Third Embodiment)

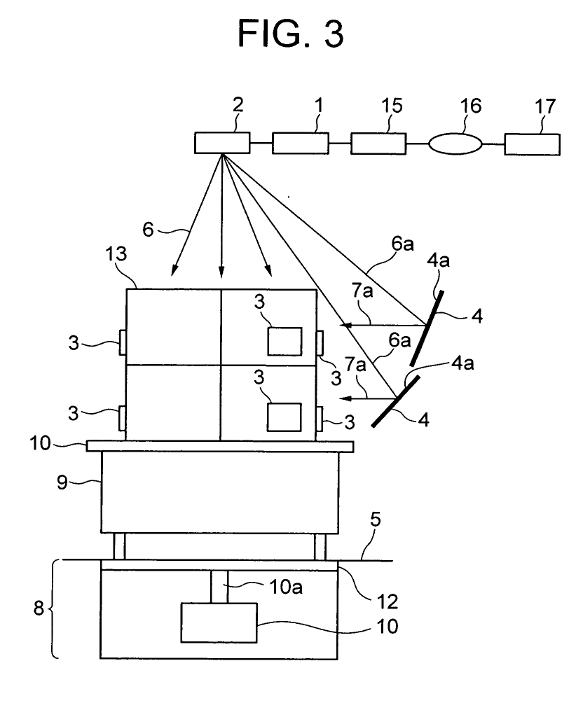

FIG. 3 is a configuration diagram for showing the wireless communication system according to a third embodiment of the present invention. In the above-described embodiments, the posture control unit 8 is constituted with the dolly 9. In the third embodiment of the present invention, however, the posture control unit 8 is constituted separately from the dolly 9.

As shown in FIG. 3, beneath the management area 5, there are provided a turntable 12 for loading and rotating the dolly 9 and a driving source 10 for angularly rotating the turntable 12, in which an output shaft 10a of the driving source 10 is connected to the turntable 12. The posture control unit 8 is constituted with the turntable 12 and the driving source 10. A plurality of reflecting plates 4 are attached in the lateral direction of the turntable 12 almost vertically by sandwiching the management area 5 by using fittings or the like. Alternatively, the plurality of reflecting plates 4 are hung in the lateral direction from the fittings or the like by cords or the like almost vertically. When the dolly 9 passing through the management area 5 comes loaded on the turntable 12 placed underneath the main antenna 2, the platform truck 9, the metal cases 13 piled up on the dolly 9, and the RFID tags 3 attached to the metal cases 13 stat to rotate.

When the driving source 10 angularly rotates the turntable 12, the dolly 9 supported by the turntable 12 is angularly rotated. During the period when the dolly 9 is angularly rotated, the main antenna 2 repeatedly transmits the inquiry signals towards the RFID tags 3 of the metal cases 13 that are piled up stereoscopically on the dolly 9, and performs communication with each of the RFID tags 3 that have responded. The computer terminal 15 stores the identification numbers of the RFID tags 3 which replied and with which communications have been completed, respectively. The velocity to angularly rotate the turntable 12 is set at a velocity capable of completing a series of communication in which the RFID tags 3 decode the inquiry signals from the direct waves 6 or the reflected waves 7a and transmit the reply signals in response to the main antenna 2, and the communication between the RFID tags 3 and the main antenna 2 is exchanged thereafter for several times to complete the communication.

In the embodiment shown in FIG. 3, reception of the direct waves 6 from the main antenna 2 and the reflected waves 7a from the reflecting plates 4 by each of the RFID tags 3, and the function of the posture control unit 8 to control the facing directions of the antenna surfaces of the RFID tags 3 with respect to the reflected waves 7a are executed in the same manner as that of the first embodiment.

Furthermore, in this embodiment of the present invention, the posture control unit 8 is constituted separately from the dolly 9. Thus, it is unnecessary to modify the structure of the dolly 9, and the dolly 9 that has been used conventionally can be utilized as it is. Moreover, the posture control unit 8 is built in the underground of the management area 5, so that it is possible to avoid the control unit 8 to interfere with transportation of the dolly 9 on the management area 5.

(Fourth Embodiment)

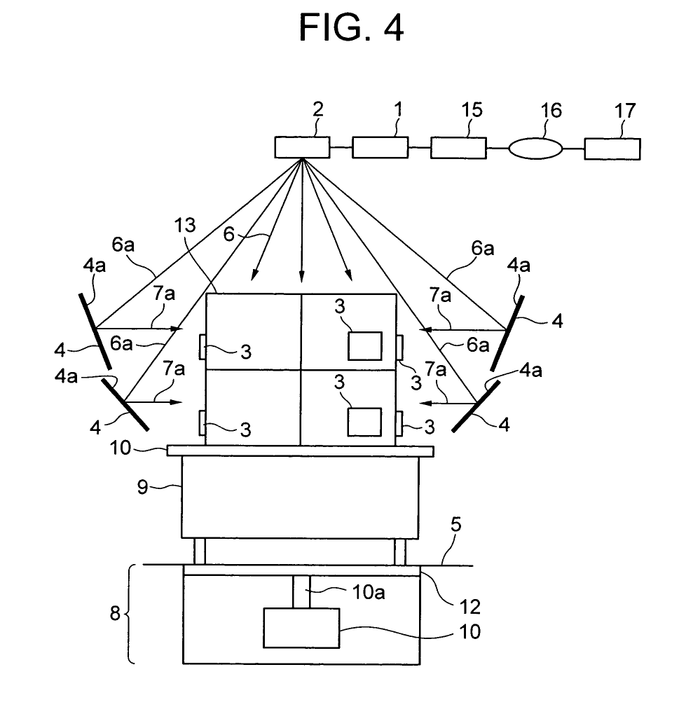

FIG. 4 is a configuration diagram for showing the wireless communication system according to a fourth embodiment of the present invention. In this embodiment of the present invention, the reflecting plates 4 shown in DIG. 3 are arranged to surround the management area 5. That is, a plurality of reflecting plates 4 are divided in two sets, and the respective sets of reflecting plates 4 are placed on opposite walls of a store or a factory or on opposite sides over a passage of a store or a production line of a factory by using fittings or the like so as to be arranged to surround the management area 5. Alternatively, a plurality of reflecting plates 4 may be hanged on both sides almost vertically from fittings or the like with ropes or the like. The plurality of reflecting plates 4 on both walls or on both sides are attached while being inclined to reflect the electromagnetic waves 6a from the main antenna 2 to radiate the reflected waves 7a in the horizontal direction or at an angle close to the horizontal direction. To the RFID tags 3 attached on the top faces of the metal cases 13 piled up stereoscopically, the direct electromagnetic wave 6 is radiated from the main antenna 2 from above, and to the RFID tags 3 attached to the side faces of the metal cases 13, the reflected waves 7a and 7b are radiated from the reflecting plates 4 arranged horizontally on the both sides.

In FIG. 4, for the RFID tags 3 attached to the right-side faces and the left-side faces of the metal cases 13 piled up on the dolly 9, there are formed the effective communication paths via the reflected waves 7a from each of the reflecting plates 4 on the right side and the left side. Thereby, communication can be performed between the main antenna 2.

However, the RFID tags 3 attached to the front faces and rear faces of the metal cases 13 cannot perform communication with the main antenna 2, since the direct waves 6 from the main antenna 2 and the reflected waves 7a from the reflecting plates 4 are reflected by the metal cases 13 and the level of received electromagnetic waves becomes deteriorated.

The velocity to angularly rotate the top plate 9b of the dolly 9 is set at a velocity capable of completing a series of communication in which the RFID tags 3 decode the inquiry signals from the reflected waves 7a and transmit the reply signals in response to the main antenna 2 via the reflecting plates 4, and the communication between the RFID tags 3 and the main antenna 2 is exchanged thereafter for several times to complete the communication.

The metal cases 13 and the RFID tags 3 attached to the metal cases 13 on the dolly 9 continue to rotate angularly, and the inquiry signals from the main antenna 2 are also transmitted repeatedly. By the clockwise-turning at an angle of 90 degrees, the RFID tags 3 attached to the rear faces of the metal cases 13 come to face the reflecting faces 4a of the reflecting plates 4 on the right side, and the RFID tags 3 attached to the front faces of the metal cases 13 come to face the reflecting faces 4a of the reflecting plates 4 on the left side so as to form the effective communication paths via the reflecting plates 4. The RFID tags 3 at the front and rear faces transmit the reply signals towards the main antenna 2 in response to the inquiry signals from the main antenna 2 to start communication.

By utilizing the reflecting plates 4 on both sides, communication is exchanged with all the RFID tags 3 that are attached to the outer side faces of the metal cases 13 through angular rotation of at least 90 degrees, and the computer terminal 15 stores the identification numbers of the RFID tags 3 that have ended the communication. The computer terminal 15 judges that communication with all the RFID tags 3 attached to the outer side faces of the metal cases 13 are completed and the identification numbers thereof are stored, and stops the transmission of the inquiry signals from the main antenna 2. At the same time, the angular rotation of the top plate 9b of the dolly 9 is stopped, and the dolly 9 starts to move ahead the passageways or the production line.

In the embodiment of the present invention, the reflecting plates 4 are arranged on both sides of the control area 5, and the communication paths of the electromagnetic waves utilizing the reflecting plates 4 are formed, respectively, between the main antenna 2 and the RFID tags 3 attached to the side faces of the metal cases 13. Thus, the embodiment is advantageous in respect that it is capable of controlling the posture within the range of at least 90 degrees for performing the data communication between the main antenna 2 and the RFID tags 3 attached to the side faces of the metal cases 13.

Although the present invention is applied to manage articles in the embodiments described above, the present invention is not limited to this configuration. Wireless IC chips (e.g., RFID tags) may be attached to articles, members or devices transferred through belt conveyers or by dollies so as to manage them. Further, wireless IC chips (e.g., RFID tags) may be attached to articles, members or devices stored in a factory, a warehouse or a distribution channel so as to manage them. Moreover, wireless IC chips (e.g., RFID tags) maybe held by or attached to humans or animals to thereby apply the present invention in recognizing the humans or individuals, or in managing entrance and exit.

In the present invention as described above, the electromagnetic waves from the main antenna are directed towards the wireless IC chips of the managing targets through the detour paths formed by the reflecting plates even in the case where the managing targets are metal-made items or liquids which reflect or absorbs the electromagnetic waves. Therefore, even if the electromagnetic waves from the main antenna are interfered with the managing targets, the electromagnetic waves can be surely led to the wireless IC chips.

What is claimed is:

1. A wireless communication system, comprising:
a main antenna for radiating electromagnetic waves towards a wireless IC chip;
a reflecting plate for forming a detour path of an electromagnetic wave that is interfered with a managing target to which the wireless IC chip is attached; and
a posture control unit for controlling facing direction of the wireless IC chip with respect to the electromagnetic wave that travels the detour path formed by the reflecting plate.

2. The wireless communication system as claimed in claim 1, wherein the posture control unit angularly rotates the managing target to control the facing direction of the wireless IC chip with respect to the electromagnetic wave that travels the detour path formed by the reflecting plate.

3. The wireless communication system as claimed in claim 1, wherein the posture control unit angularly rotates a dolly that supports the managing target to control the facing direction of the wireless IC chip.

4. The wireless communication system as claimed in claim 1, wherein the posture control unit angularly rotates the managing target on a dolly to control the facing direction of the wireless IC chip.

5. The wireless communication system as claimed in claim 1, wherein there are a plurality of the reflecting plates arranged on a plurality of stages along mounting direction of the managing targets.

6. The wireless communication system as claimed in claim 5,
wherein the reflecting plates are arranged on one side of the mounted managing targets.

7. The wireless communication system as claimed in claim 5,
wherein the reflecting plates are arranged on both sides of the mounted managing targets.

8. A wireless communication method, comprising the steps of:
in addition to paths of electromagnetic waves radiated from a main antenna to a wireless IC chip, a path forming step for forming a detour path of an electromagnetic wave that is interfered with a managing target to which the wireless IC chip is attached; and
a posture control step for controlling facing direction of the wireless IC chip with respect to the electromagnetic wave that travels the detour path formed by the reflecting plate.
